(19) United States
(12) Patent Application Publication
(10) Pub. No.: US 2007/0052646 A1
(43) Pub. Date: Mar. 8, 2007

(54) DISPLAY DEVICE

(75) Inventor: Kazuhiro Ishiguchi, Kumamoto (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/468,136

(22) Filed: Aug. 29, 2006

(30) Foreign Application Priority Data
Sep. 7, 2005 (JP) 2005-259028

(51) Int. Cl. G09G 3/36

(52) U.S. Cl. 345/92

(57) ABSTRACT

There is disposed a TFT for detecting characteristic having the same characteristic as a pixel TFT disposed at a pixel. The TFT for detecting characteristic detects a gate on voltage for driving the pixel TFT. The TFT for detecting characteristic is driven so as to agree with the pixel TFT in a period of the on state. This provides a display device that is capable of driving the pixel TFT at its optimum driving voltage with a simple circuit configuration, even when the characteristic of the pixel TFT is subjected to temperature change, aged change, and individual variations.

### BACKGROUND OF THE INVENTION

1. Field of the Invention

The present invention relates to a display device using a thin film transistor.

2. Description of the Background Art

An active matrix display using a thin film transistor (TFT) as a switching element has been used for a variety of applications as a thin display device, such as one using a liquid crystal for optical control, and one using organic EL as a luminescent source.

Examples of its typical applications are display devices of PCs, car navigation systems, ATMs, and POSs. Among these, the car navigation systems and the ATMs placed outdoors will be used under temperature environments in a very wide range, and the display devices are also required to operate in a wide temperature range.

In a wide operating temperature range, characteristic variations due to the temperatures of the respective parts of a display device may cause the problem of image quality deterioration. Especially in a low temperature region, in some cases, a TFT disposed at a pixel does not have enough mobility, failing to obtain a desired display characteristic.

As an example, consider an LCD (liquid crystal display). When a functional block of an existing LCD is used, the driving voltage of a TFT is constant irrespective of operating conditions (temperatures). Hence, the TFT has poor mobility at low temperatures. This results in a significant reduction in contrast due to a deficiency of charging to the pixel.

In order to solve this problem, Japanese Patent Application Laid-Open No. 2003-255304 discloses the invention that a temperature sensor such as a thermistor is used to detect a temperature to generate the driving voltage of a pixel TFT suitable for the temperature.

On the other hand, the invention described in Japanese Patent Application Laid-Open No. 02-124530 proposes the system that pixels for detecting characteristic are disposed on the outside of a display region, and the brightness at there is measured and a signal line and a common voltage are changed to set an optimum driving condition.

It is however extremely difficult to absorb variations (individual variations) in TFT characteristic between LCDs by the means of detecting the temperature with the temperature sensor such as the thermistor, and then generating the driving voltage suitable for the detected temperature, as described above. It is also impossible to detect the aged change of the TFT after prolonged use.

For this reason, the above Japanese Patent Application Laid-Open No. 2003-255304 further discloses, as temperature detecting means, a system of determining an optimum driving condition in which a TFT for detecting characteristic is used to monitor and feedback its characteristic. The TFT for detecting characteristic is incorporated at the same time as TFTs (pixel TFTs) disposed in the pixels of the display device.

With this system, the individual variations in the TFT characteristic can be absorbed, whereas the TFT for detecting characteristic is always in an on state, causing its threshold value shift. As a result, the TFT for detecting characteristic and the pixel TFTs have completely different characteristics, making no sense to use the TFT for detecting characteristic.

The invention as described in the above Japanese Patent Application Laid-Open No. 02-124530 is capable of solving the above-mentioned problem that only the characteristic of the TFT for detecting characteristic is shifted, because the TFT for detecting characteristic can be driven under the same condition as the pixel TFTs.

It may, however, become necessary to dispose a brightness sensor. This increases the external shape of the display device and complicates the circuit configuration.

### SUMMARY OF THE INVENTION

An object of the present invention is to provide a display device with a simple circuit configuration that enables a pixel TFT to be driven at its optimum driving voltage even when the characteristic of the pixel TFT is subjected to temperature change, aged change, and individual variations.

According to a first aspect of the present invention, a display device includes: a plurality of pixels that are arranged in a matrix-shape on a substrate and are respectively provided with a pixel TFT; and at least one TFT for detecting characteristic that is formed on the substrate so as to have the same characteristic as the pixel TFT, and detects an on voltage or an off voltage for driving the pixel TFT. The at least one TFT for detecting characteristic is driven so as to agree with the pixel TFT in a period of an on state.

The TFT for detecting characteristic is driven so as to agree with the pixel TFT in the period of the on state, allowing it to be subjected to the same aged change as the pixel TFT. This requires no brightness sensor and enables a simple circuit configuration to control the pixel TFT in response to its aged change.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a display device according to a first preferred embodiment of the present invention;

FIG. 2 is a schematic diagram for explaining a detected voltage that a TFT for detecting characteristic of the first preferred embodiment outputs to a power supply circuit;

FIG. 3 is a timing chart showing a timing of driving pixel TFTs of the first preferred embodiment;

FIG. 4 is a circuit diagram showing the configuration of the power supply circuit in the first preferred embodiment;

FIG. 5 is a diagram showing the change with time of a source driver output voltage in the first preferred embodiment;

FIG. 6 is a circuit diagram showing the configuration of n-stage parallel-connected TFTs for detecting characteristic in the first preferred embodiment;

FIG. 7 is a simplified equivalent circuit diagram of a liquid crystal pixel in the first preferred embodiment;

FIG. 8 is a circuit diagram showing the configuration of a common voltage generating circuit in the first preferred embodiment;

FIG. 9 is a block diagram of a display device according to a second preferred embodiment;

FIG. 10 is a circuit diagram showing the configuration of peripheral circuits of a TFT for detecting characteristic in the second preferred embodiment;

FIG. 11 is a circuit diagram showing the configuration of peripheral circuits of a TFT for detecting characteristic in a third preferred embodiment;

FIG. 12 is a circuit diagram showing the configuration of a common voltage generating circuit in the third preferred embodiment;

FIG. 13 is a circuit diagram showing the configuration of peripheral circuits of a TFT for detecting characteristic in a fourth preferred embodiment;

FIG. 14 is a circuit diagram showing the configuration of a gate driver circuit according to a fifth preferred embodiment;

FIG. 15 is a circuit diagram showing the configuration of a display device according to a sixth preferred embodiment; and

FIG. 16 is a diagram for explaining the operation of the display device of the sixth preferred embodiment.

### DESCRIPTION OF THE PREFERRED EMBODIMENTS

### First Preferred Embodiment

A. Configuration

A-1. Overall Configuration

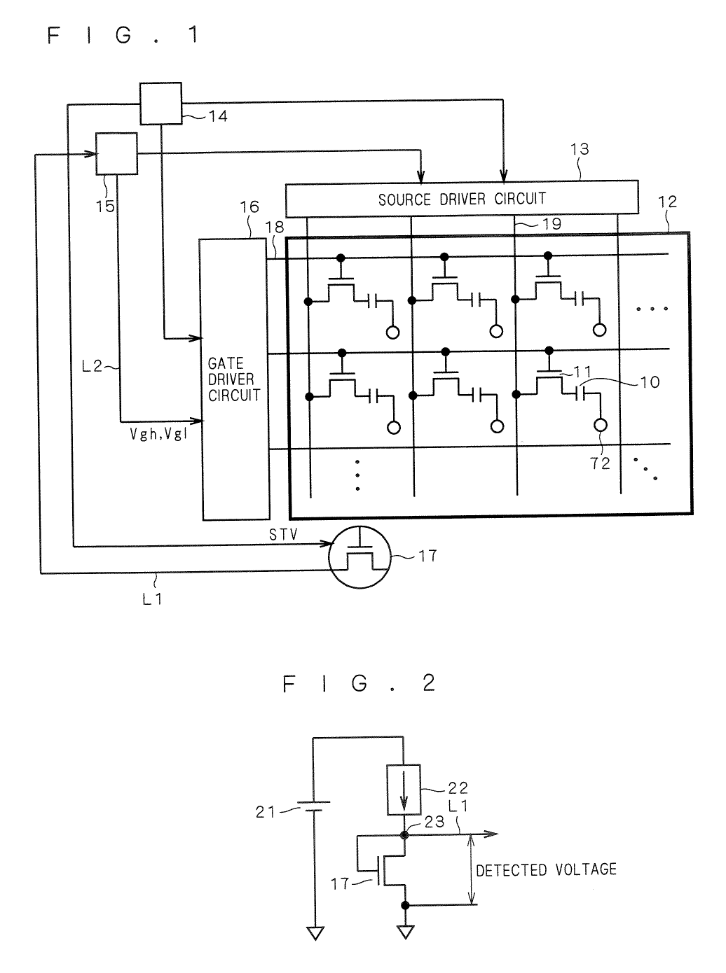

FIG. 1 is a block diagram of a display device according to a first preferred embodiment of the present invention. Pixels are arranged in a matrix-shape in a display area (a display region) 12 on a substrate, each of which is provided with a pixel TFT 11 that is an n-channel MOSFET.

A pixel capacity 10 is connected to the drain of each of the pixel TFTs 11. A gate driver circuit (a gate driving circuit) 16, which drives the pixel TFTs 11 per scanning line (gate wiring) 18, is connected to the gate of each of the pixel TFTs 11. A source driver circuit 13, which determines an applied voltage to the pixel capacity 10, is connected via a data line 19 to the source of each of the pixel TFTs 11.

One end of the pixel capacity 10 is connected to the drain of the pixel TFT 1, and the other end of the pixel capacity 10 is connected to a terminal 72. A later-described common voltage is applied to the terminal 72.

The gate driver circuit 16 and the source driver circuit 13 are connected to a control signal circuit 14 and controlled by a signal supplied from the control signal circuit 14. The source driver circuit 13 is connected to a power supply circuit 15 and driven by a driving power source supplied from the power supply circuit 15.

A gate on voltage Vgh and a gate off voltage Vgl are supplied from the power supply circuit 15 via a line L2 to the gate driver circuit 16. The gate on voltage Vgh is a voltage applied to the gate of the pixel TFT 11 when turning it on. The gate off voltage Vgl is a voltage applied to the gate of the pixel TFT 11 when turning it off.

Aside from the pixels TFT 11, a TFT 17 for detecting characteristic (in some cases, hereinafter referred to simply as “TFT 17”) is connected via a line L1 to the power supply circuit 15. The TFT 17 for detecting characteristic is formed on said substrate so as to have the same characteristic in the same process as the pixel TFT 11.

The TFT 17 for detecting characteristic is disposed in the display area 12 or the outside of the display area 12. The TFT 17 outputs a detected voltage via the line L1 to the power supply circuit 15. The TFT 17 is also connected to the control signal circuit 14. The control signal circuit 14 outputs a signal STV to the TFT 17.

The source driver circuit 13, the gate driver circuit 16, the control signal circuit 14, and the power supply circuit 15 may be formed at the same time on the substrate with the pixel TFTs 11 and the TFT 17 for detecting characteristic formed thereon. Alternatively, these circuits may be formed on another substrate.

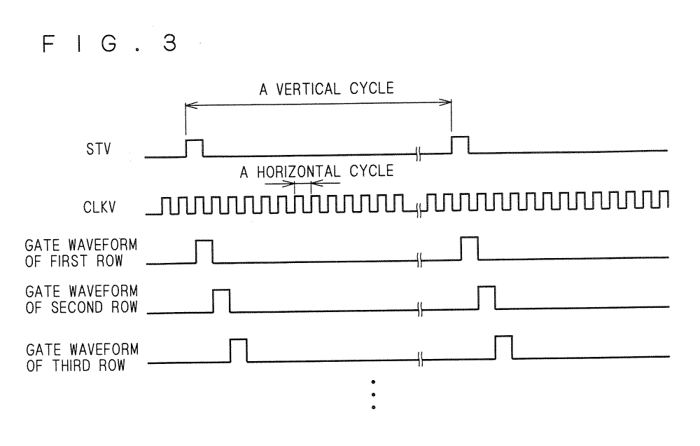

FIG. 2 is a schematic diagram for explaining a detected voltage that the TFT 17 for detecting characteristic outputs to the power supply circuit 15.

At a connecting part 23, the gate (the control terminal) of the TFT 17 for detecting characteristic is connected to the drain (the current input terminal) thereof. The source of the TFT 17 is grounded. One end of a constant current source 22 is connected to the connecting part 23. The other end of the constant current source 22 is connected to a power source 21. The other end of the power source 21 is grounded.

The constant current source 22 and the power source 21 are contained in the power supply circuit 15 (FIG. 1). In FIG. 1, the lines that connect the constant current source 22 and the power source 21 to the drain of the TFT 17 for detecting characteristic are omitted. In FIG. 2, the line through which a signal STV is inputted to the TFT 17 is also omitted.

In the connecting part 23, the TFT 17 for detecting characteristic is connected via the line L1 to the power supply circuit 15, and the constant current source 22 applies a constant bias current to the TFT 17.

Here, letting a source-drain voltage Vds of the TFT 17 for detecting characteristic be a detected voltage. In a drain current Id characteristic of the TFT 17, ∂Id/∂Vgs is sufficiently larger than ∂Id/∂Vds, so that a gate on voltage Vgh substantially required to flow a bias current appears in the detected voltage.

By setting, as a bias current, a current value required to charge the pixel capacity 10 (pixel charging) to the constant current source 22, a gate on voltage Vgh necessary for pixel charging when turning on the pixel TFT 11 can be generated automatically as a detected voltage. The detected voltage is then outputted via a line 21 to the power supply circuit 15.

In consideration of various error factors, it is preferable to set the value of a bias current, without setting to the exact current value necessary for pixel charging, to a slightly large current value in consideration of a margin, or set to a slightly small current value and then add a small current value on a subsequent stage circuit.

It should be noted that, when the TFT 17 for detecting characteristic is formed by amorphous silicon, the TFT 17 is always in the on state, and the channel of the TFT 17 traps carriers. This leads to the phenomenon that the threshold value of the TFT 17 as being an enhanced type MOSFET shifts to the threshold value of a depression type MOSFET.

When only the threshold value of the TFT 17 for detecting characteristic shifts, the TFT 17 and the pixel TFTs 11 may have different characteristics. Hence, there arises the disadvantage of the possibility that the pixel TFTs 11 are not driven satisfactorily by the detected voltage outputted from the TFT 17.

For this reason, it is arranged so that the TFT 17 for detecting characteristic is also driven under the same condition as the pixel TFTs 11. The following is the configuration for driving the TFT 17 under the same condition as the pixel TFTs 11.

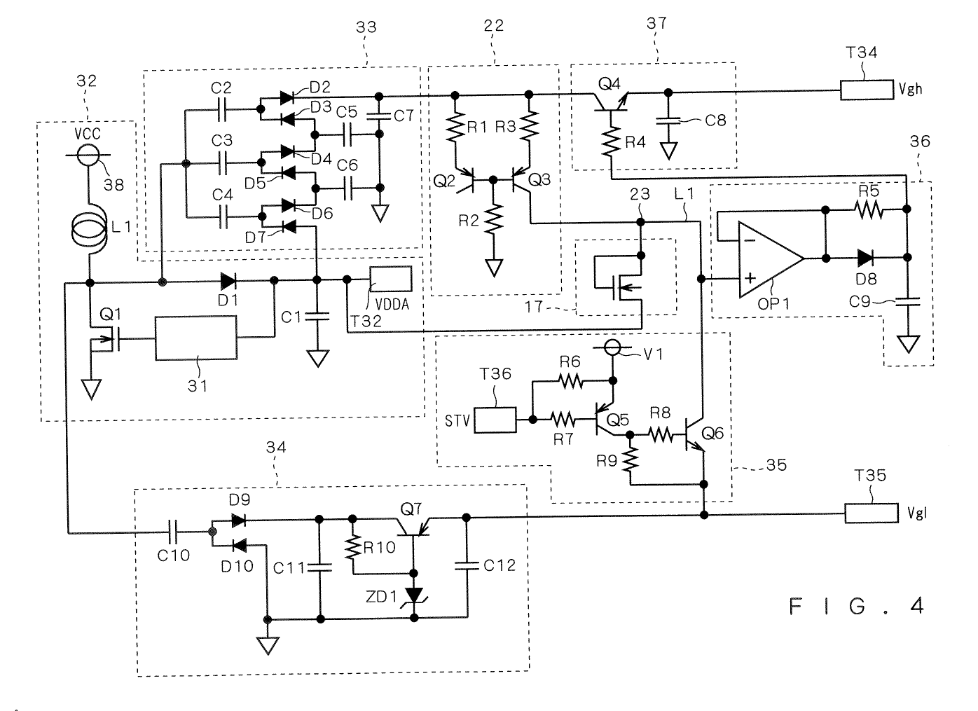

FIG. 3 is a timing chart showing the timing of driving the pixel TFTs 11. The pixel TFTs 11 are typically driven with the timing chart shown in FIG. 3. A clock CLKV is a clock using one horizontal cycle as a period. A signal STV is a start pulse indicating a start time to scan.

When the signal STV is turned on, the gates of the pixel TFTs 11 arranged in the first row in the display area 12 are sequentially turned on, and those in the first row are turned off when those in the second row are turned on. The same operation is repeated in the next frame (after a vertical cycle).

Considering any one of the pixels TFT 11 in the display area 12, this pixel TFT 11 will be turned on once in a vertical cycle, during a period of time that an on signal of a horizontal cycle is inputted.

It is also required to drive similarly the TFT 17 for detecting characteristic. Therefore, for example, when the signal STV is turned off, the TFT 17 may be sunk in a gate off voltage Vgl.

A-2. Configuration of Power Supply Circuit 15

Specific configurations of the power supply circuit 15 and the TFT 17 for detecting characteristic that realize the above-mentioned operation will be described below. FIG. 4 is a simplified circuit diagram showing the configurations of the power supply circuit 15 and the TFT 17 for detecting characteristic. The components that correspond to FIG. 2 bear the same reference numerals.

The power supply circuit 15 shown in FIG. 4 is a circuit that generates, from an input source voltage VCC, an analog voltage VDDA used in the source driver circuit 14 and a gradation reference voltage, a gate off voltage Vgl (in some cases, hereinafter referred to a voltage Vgl or an off voltage Vgl), and a gate on voltage Vgh (in some cases, hereinafter referred to as a voltage Vgh or an on voltage Vgh).

The gate on voltage Vgh and the gate off voltage Vgl are inputted to the gate driver circuit 16, and then become the voltages at the time of the gate on/off in the pixel TFTs 11, respectively. In FIG. 4, the parts other than the TFT 17 for detecting characteristic are contained in the power supply circuit 15 (refer to FIG. 1).

FIG. 1 illustrates, for sake of simplicity, the signal STV so as to be directly inputted from the control signal circuit 14 to the TFT 17 for detecting characteristic. In fact, the signal STV is inputted to the TFT 17 via a circuit 35 contained in the power supply circuit 15.

A-2-1. Configuration of Boost Converter Circuit 32

The configuration of a boost converter circuit 32 will first be described. The boost converter circuit 32 is a well-known circuit, which is a circuit to generate an analog voltage VDDA from an input source voltage VCC.

A power source 38 is connected to one end of an inductance L1. The power source 38 applies the input source voltage VCC to the one end of the inductance L1. The other end of the inductance L1 is connected to the drain of a transistor Q1. The source of the transistor Q1 is grounded.

The output of a DCDC controller 31 is connected to the gate of the transistor Q1. The other end of the DCDC controller 31 is connected to the cathode of a diode D1. The anode of the diode D1 is connected to the other end of the inductance L1.

One end of a capacity C1 is connected to the cathode of the diode D1, and the other end is grounded. One end of the capacity C1 is connected to a terminal T32. The terminal T32 outputs an analog voltage VDDA.

A-2-2. Configuration of Charge Pump Circuit 33

The configuration of a charge pump circuit 33 will be described below. The cathode of a diode D2 is connected to one end of a capacity C7, and the other end thereof is grounded. The cathode of a diode D3 is connected to the anode of the diode D2. The cathode of a diode D4 is connected to the anode of the diode D3.

The cathode of a diode D5 is connected to the anode of the diode D4. The cathode of a diode D6 is connected to the anode of the diode D5. The cathode of a diode D7 is connected to the anode of the diode D6. The anode of the diode D7 is connected to the one end of the capacity C1.

One end of a capacity C2 is connected to the anode of the diode D2. One end of a capacity C3 is connected to the anode of the diode D4. One end of a capacity C4 is connected to the anode of the diode D6. The other ends of the capacities C2 to C4 are connected to the anode of the diode D1. One end of the capacity C5 is connected to the anode of the diode D3, and the other end thereof is connected to the other end of the capacity C7. One end of the capacity C6 is connected to the anode of the diode D5, and the other end thereof is connected to the other end of the capacity C7.

A-2-3. Configuration of Series Regulator Circuit 34

The configuration of a series regulator 34 will next be described. One end of a capacity C10 is connected to the other end of the inductance L1. The anode of a diode D9 is connected to the other end of the capacity C10. The cathode of the diode D10 is connected to the anode of the diode D9, and the anode thereof is grounded.

The cathode of the diode D9 is connected to one end of a capacity C11. The other end of the capacity C11 is connected to the anode of the diode D10. One end of a resistor R10 is connected to one end of a capacity C11. The other end of the resistor R10 is connected to the anode of the Zener diode ZD1. The cathode of the Zener diode ZD1 is connected to the anode of the diode D10.

The one end of the resistor R10 is connected to the collector of a transistor Q7. The emitter of the transistor Q7 is connected to one end of a capacity C12 and to a terminal T35. The terminal T35 outputs a gate off voltage Vgl. The other end of a capacity C12 is connected to the cathode of the Zener diode ZD1.

A-2-4. Configuration of Constant Current Source 22

The configuration of a constant current source 22 will be described below. One end of a resistor R1 is connected to the one end of the capacity C7, and the other end thereof is connected to the emitter of a transistor Q2. The base of the transistor Q2 is connected to one end of a resistor R2, and the other end of the resistor R2 is grounded. The base of the transistor Q3 is connected to the one end of the resistor R2, and the emitter thereof is connected to one end of a resistor R3. The other end of the resistor R3 is connected to one end of the resistor R1 and the collector of a resistor Q4. The collector of the transistor Q3 is connected to the drain of the TFT 17 for detecting characteristic.

A-2-5. Configuration of Circuit 35

The configuration of a circuit 35 will be described below. The collector of a transistor Q6 is connected to the positive input terminal of an operational amplifier OP1 and the drain of the TFT 17 for detecting characteristic. The emitter of the transistor Q6 is connected to a terminal T35.

The base of the transistor Q6 is connected to one end of a resistor R8. The other end of the resistor R8 is connected to one end of a transistor R9 and the collector of a transistor Q5. The other end of a resistor R9 is connected to the emitter of the transistor Q6.

The base of the transistor Q5 is connected to one end of a resistor R7. The other end of the resistor R7 is connected to one end of a resistor R6 and a terminal T36. A signal STV is inputted to the terminal T36. The other end of the resistor R6 is connected to the emitter of the transistor Q5. The emitter of the transistor Q5 is connected to a power source V1.

A-2-6. Configuration of Peak Hold Circuit 36

The configuration of a peak hold circuit 36 will be described below. The negative input terminal of the operational amplifier OP1 is connected to one end of a resistor R5. The output of the operational amplifier OP1 is connected to the anode of a diode D8 and the one end of the resistor R5. The cathode of the diode D8 is connected to one end of a capacity C9 and the other end of the resistor R5. The other end of the capacity C9 is grounded.

A-2-7. Configuration of Circuit 37

The configuration of a circuit 37 will be described below. The other end of the resistor R5 is connected to one end of a resistor R4. The other end of the resistor R4 is connected to the base of the transistor Q4. The emitter of the transistor Q4 is connected to one end of a capacity C8 and a terminal T34. The other end of the capacity C8 is grounded. The terminal T34 outputs a gate on voltage Vgh.

A-2-8. Configuration of TFT 17 for Detecting Characteristic

The configuration of the TFT 17 for detecting characteristic will be described below. The drain and the gate of the TFT 17 are connected to each other. The drain of the TFT 17 is connected, at the connecting part 23, to the collector of the transistor Q3 that constitutes the constant current source 22. The source of the TFT 17 is connected to a terminal T32.

B. Operation

The operations of the power supply circuit 15 and the TFT 17 for detecting characteristic as shown in FIG. 4 will be described below. The boost converter circuit 32 generates an analog voltage VDDA from an input source voltage VCC. It is assumed here that the input source voltage VCC is set to 3.3 V, and the generated analog voltage VDDA is set to 10 V.

As a result, the voltage of the drain of the transistor Q1 becomes a rectangular wave of about 10 V, so that the series regulator circuit 34 generates a gate off voltage Vgl of the negative voltage and then outputs it from the terminal T35, where the gate off voltage Vgl is −6 V from the value of the Zener diode ZD1.

A charge pump circuit 33 raises the voltage generated at the other end of the inductance L1, and generates a voltage of 35 V at one end of the capacity C7. When applied a voltage of 35 V from the one end of the capacity C7, the constant current source 22 outputs the set bias current to the anode (the connecting part 23) of the diode-connected TFT 17 for detecting characteristic.

Although the constant current source 22 is configured with a transistor, when no precision is needed, only a resistor can replace the constant current source 22.

When a bias current is inputted to the anode of the diode-connected TFT 17 for detecting characteristic, the TFT 17 outputs a detected voltage from the connecting part 23 via the line L1, by the operation described with reference to FIG. 2. The detected voltage is outputted to the positive input terminal of the operational amplifier OP1 that constitutes the power supply circuit 15.

A gate off voltage Vgl is inputted via the transistor Q6 to the anode of the diode-connected TFT 17 for detecting characteristic. The transistor Q6 operates to establish an electrical conductivity when the signal STV is turned off, and establish no electrical conductivity when the gate off voltage Vgl is inputted to the anode of the TFT 17, and the signal STV is turned on.

More specifically, when the signal STV is turned off, a base current flows from the power source V1 via the resistors R6 and R7 to the transistor Q5, and the transistor Q5 establishes an electrical conductivity. At this time, the base current flows from the power source V1 via the resistance R8 to the transistor Q6, and the transistor Q6 establishes an electrical conductivity.

When the signal STV is turned on, no base current flows via the resistors R6 and R7 to the transistor Q5, so that the transistor Q5 is turned off. As a result, no base current flows to the transistor R6, so that the transistor Q6 establishes no electrical conductivity.

Thus, the TFT 17 for detecting characteristic enters the on state only when the signal STV is turned on, namely only an on period of a horizontal cycle once in a vertical cycle (provided that the on period of the signal STV is set to be equal to the on period of a horizontal cycle).

By the foregoing operation, the detected voltage outputted from the TFT 17 for detecting characteristic varies between the gate on voltage Vgh that flows the set bias current, and the gate off voltage Vgl. Therefore, the peak hold circuit 36 for canceling the gate off voltage Vgl is connected to the anode of the TFT 17.

When the gate on voltage Vgh is inputted to the positive input terminal of the operational amplifier OP1, the peak hold circuit 36 charges the capacity C9 up to the gate on voltage Vgh.

On the other hand, when the gate off voltage Vgl is inputted to the positive input terminal of the operational amplifier OP1, the output of the operational amplifier OP1 will be lowered, whereas the voltage of the capacity C9 is held by the presence of the diode D8.

When the voltage of the capacity C9 is inputted to the base of the transistor Q4 of a current buffer, the gate on voltage Vgh is charged into the capacity C8 and then outputted from the terminal T34 (Strictly speaking, the value corresponding to a component such as VBE should be reduced from the value of the detected voltage.).

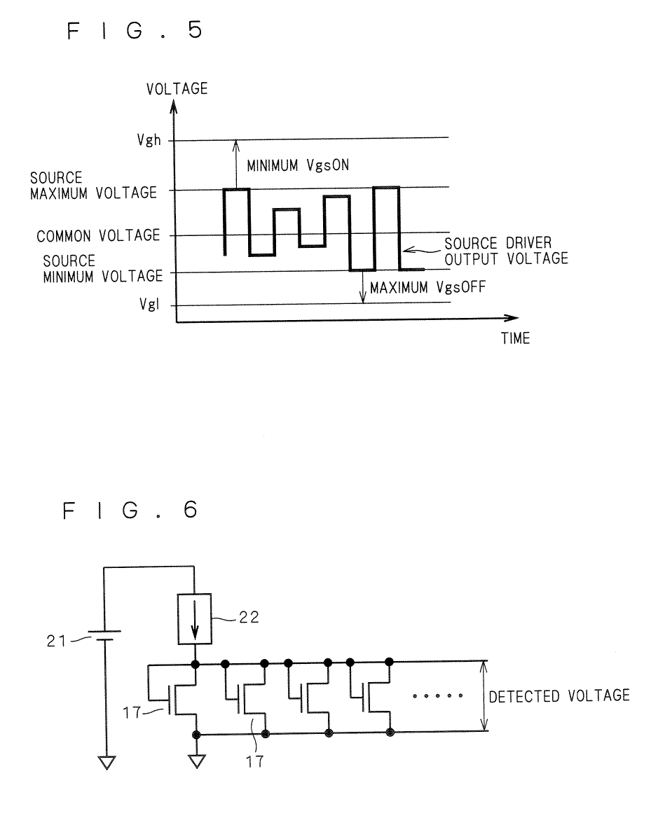

The reason why the cathode side of the TFT 17 for detecting characteristic is connected to the analog voltage VDDA is as follows. FIG. 5 is a diagram showing the change with time of the output voltage of a general source driver circuit 13 (a source driver output voltage).

A desired voltage necessary for display is outputted per scanning time from the source driver circuit 13. Its maximum voltage is normally a voltage slightly (several hundreds mV) lower than an analog voltage VDDA, and its minimum voltage is normally a voltage slightly (several hundreds mV) higher than a ground voltage (GND).

Consequently, in the gate voltage Vgs applied to the pixel TFTs 11, its minimum value in the on state is approximately Vgh−VDDA, and its maximum value in the off state (In the drawing, the gate voltage Vgs is negative, and therefore the absolute value becomes the minimum value) is approximately Vgl−GND.

Hence, the possible minimum value of the gate voltage Vgs in the on state is approximately Vgh−VDDA, so that the cathode side of the TFT 17 for detecting characteristic is also connected to the VDDA of the worst case. When the gate voltage Vgs is different from this due to the driving system, it may be connected to such a voltage as to minimize the gate voltage Vgs in the on state.

It is preferable that the TFT 17 for detecting characteristic is made identically equal to the pixel TFT 11. On the other hand, the pixel TFT 11 drives only the pixel capacity 10, and hence its mobility is normally very small. For this reason, if the TFT 17 is identical with the pixel TFT 11, in some cases, the wiring extending from the TFT 17, and the wiring capacity of a peripheral circuit and the like for executing the same drive as the pixel TFT 11 cannot be driven sufficiently.

In the event of failure to sufficiently drive them, if desired to detect the gate on voltage Vgh from the TFT 17 for detecting characteristic only during the on period of a horizontal cycle within the period of a vertical cycle, the peripheral circuit will not rise sufficiently, failing to detect the gate on voltage Vgh. Further, it cannot ignore the influences of a breaking current (a leak current) and a disturbance noise of the peripheral circuit, which might cause a large error in the detected voltage.

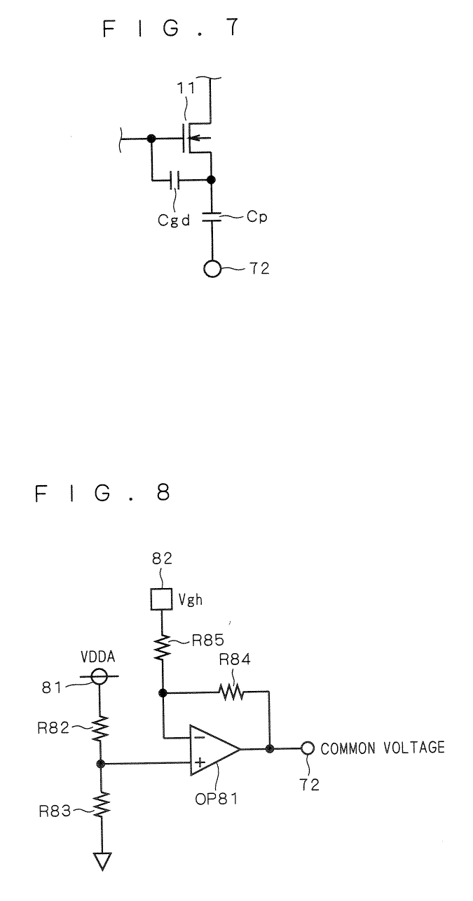

To avoid these problems, it is necessary to increase the mobility of the TFT 17 for detecting characteristic. In order to increase the mobility while holding the same characteristic as the pixel TFT 11, a plurality of TFTs 17 may be connected in parallel and at an n-stage, as shown in FIG. 6.

For example, when the drain current Id required to charge the pixel capacity 10 is set to 100 nA, the setting current (the bias current) of the constant current source 22 may be set to 100 nA. In the case where a maloperation occurs by the influence of the peripheral circuit, and therefore a setting current of at least 1 μA is needed, ten TFTs 17 for detecting characteristic may be connected in parallel, and the setting current of the constant current source 22 may be set to 1 μA.

With the circuit configuration as described above, the TFTs 17 for detecting characteristic output the gate on voltage Vgh required to charge the pixel capacity 10 to the power supply circuit 15, enabling the power supply circuit 15 to dynamically change the gate on voltage Vgh.

The dynamic change of the gate on voltage Vgh calls for a change of the common voltage that is the one-sided voltage of a liquid crystal pixel electrode.

FIG. 7 is a simplified equivalent circuit diagram of a liquid crystal pixel. One end of a capacity Cp is connected to the drain of the pixel TFT 11. As used herein, the capacity Cp is generally the sum of a liquid crystal capacity Clc and a holding capacity Cs of the pixel capacity 10.

The other end of the capacity Cp is connected to the terminal 72. A common voltage is applied to the terminal 72. A gate-drain capacity Cgd is connected between the gate and the drain of the pixel TFT 11. The gate-drain capacity Cgd is the gate-drain capacity that the pixel TFT 11 has essentially.

As described with reference to FIG. 1, the source of the pixel TFT 11 is connected to the source driver circuit 13, and the gate of the pixel TFT 11 is connected to the gate driver circuit 16.

Immediately before the pixel TFT 11 is turned off, a pixel voltage (the voltage of the capacity Cp on the side thereof to which the pixel TFT 11 is connected) is substantially the same as the source voltage of the pixel TFT 11.

Nevertheless, when the gate voltage is turned off, the pixel voltage will be lowered by the value given by Cgd/Cp×(Vgh−Vgl), wherein Cgd and Cp also indicate the values of the capacity Cgd and the capacity Cp, respectively.

With this in mind, the common voltage is normally set so that the voltage applied to the capacity Cp is held constant. Because the gate on voltage Vgh is dynamically changed in the invention according to the first preferred embodiment, means for dynamically correcting the common voltage is needed.

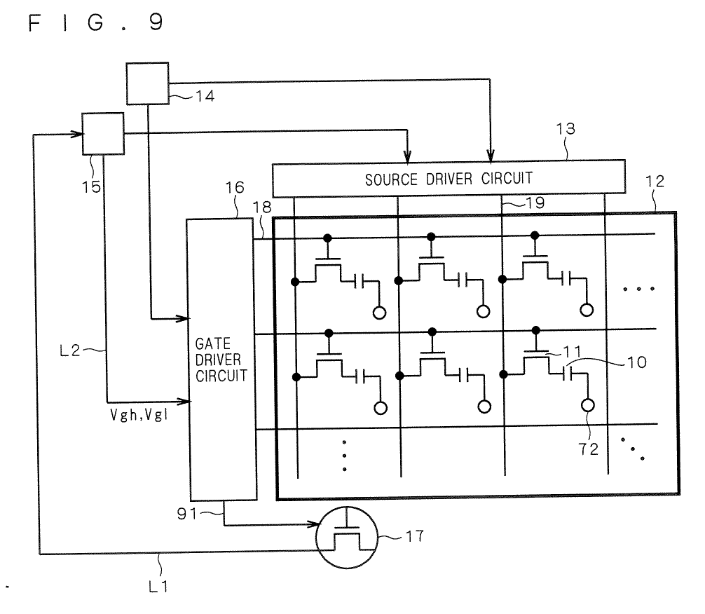

FIG. 8 is a circuit diagram showing the configuration of a common voltage generating circuit in the first preferred embodiment. One end of a resistor R82 and one end of a resistor R83 are connected to the positive input terminal of an operational amplifier OP 81. The other end of the resistor R82 is connected to a terminal 81, and an analog voltage VDDA is applied to the terminal 81. The other end of the resistor R82 is grounded.

One end of a resistor R85 and one end of a resistor R84 are connected to the negative input terminal of an operational amplifier OP82. The other end of the resistor R85 is connected to a terminal 82, and a gate on voltage Vgh is applied to the terminal 82. The other end of the resistor R84 is connected to the output of the operational amplifier OP81. The output of the operational amplifier 81 is connected to the terminal 72, and outputs a common voltage.

The common voltage generating circuit is so configured, and therefore its output contains a portion to give −(R84/R85)×Vgh. Accordingly, by suitably adjusting the magnitudes of the resistors R85 and R84 in response to the value of Cgd/Cp, the common voltage can be changed dynamically so that the voltage applied to the capacity Cp is held constant in response to the change of the voltage Vgh.

C. Effects

In the display device of the first preferred embodiment, the TFT 17 for detecting characteristic is driven so as to agree with the pixel TFTs 11 in the period of the on state. Like the pixel TFTs 11, the TFTs 17 are also subjected to aged deterioration. In the event of aged deterioration in the pixel TFTs 11, it is possible to output the gate on voltage Vgh of enough magnitude to flow the drain current Id.

Further, the TFTs 17 for detecting characteristic have the same characteristic as the pixel TFTs 1, enabling to cope with the individual variations during the manufacturing, and with the aged change after prolonged use.

In the display device of the first preferred embodiment, the gate and the drain of the TFT 17 for detecting characteristic are connected to each other. When applied a bias current to the connecting part therebetween, the TFT 17 detects the gate on voltage Vgh for driving the pixel TFT 11.

Accordingly, this simple circuit configuration enables the gate on voltage Vgh of the pixel TFT 11 to be changed automatically, for example, with variations in operating temperature condition.

That is, when the mobility of the pixel TFTs 11 are insufficient in a low temperature region, the mobility can be increased by automatically increasing the voltage Vgh. On the other hand, decreasing the voltage Vgh in a high temperature region permits suppressions of the characteristic deterioration of the pixel TFT 11 and a reduction in the unnecessary power, and prevention of display quality deterioration caused by a high voltage Vgh.

The display device of the first preferred embodiment is provided with the common voltage generating circuit that commonly applies a common voltage to the plurality of pixels, and the common voltage is changed in response to the gate on voltage Vgh. This enables a constant voltage to be applied to the pixel capacity 10 even with variations in the gate on voltage Vgh.

The display device of the first preferred embodiment is further provided with the plurality of TFTs 17 for detecting characteristic, and these TFTs 17 are connected in parallel. It is therefore possible to increase the mobility of the parallel-connected TFTs 17 as a whole, while holding the same characteristic as the pixel TFTs 11.

Although the first preferred embodiment has discussed the case of the LCD, the technique of determining the gate on voltage Vgh from the characteristic of the TFTs 17 for detecting characteristic is applicable to other display devices (e.g., organic ELs) that have a problem in the mobility of TFTs with variations in temperature, and to integrated circuits formed by TFTs.

### Second Preferred Embodiment

In the display device of the first preferred embodiment, the description has been made of the case where the bias current generated at the constant current source 22 is flown to the TFT 17 for detecting characteristic in order to obtain the gate on voltage Vgh at that time.

In the display device of a second preferred embodiment, a gate driver circuit 16 drives a TFT 17 for detecting characteristic in order to detect the drain current Id passing through the TFT 17. By a feedback loop, the value of the gate on voltage Vgh is changed to obtain such a gate on voltage Vgh as to attain the drain current Id of a desired value (the value of the drain current Id required to charge the capacity Cp).

The configuration of the display device of the second preferred embodiment will be described below.

A. Configuration

A-1. Overall Configuration

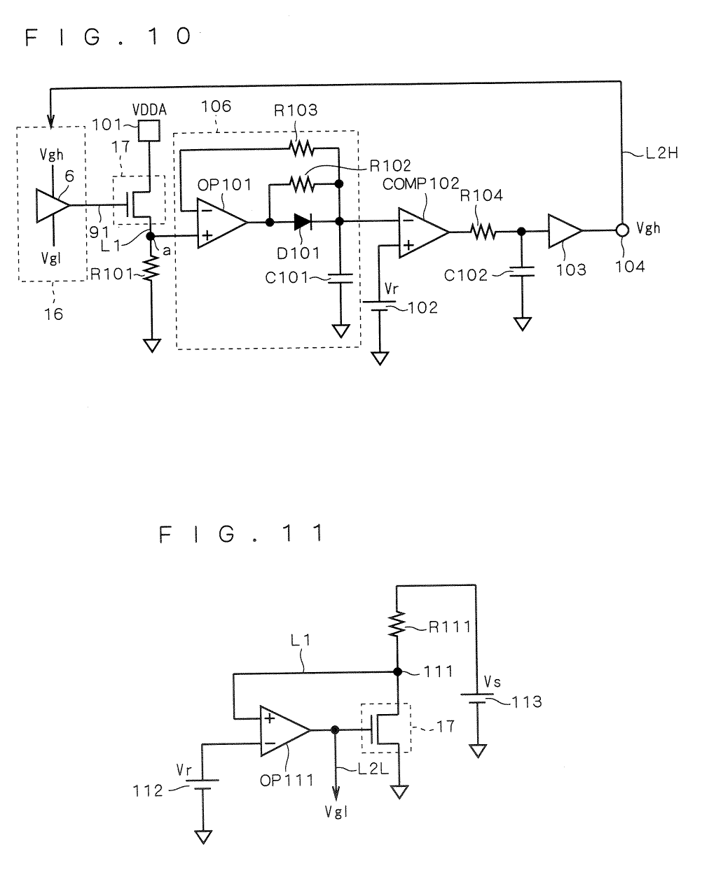

FIG. 9 is a block diagram of the display device of the second preferred embodiment. The second preferred embodiment has the same configuration as the first preferred embodiment, except that no signal STV is inputted from the control signal circuit 14 to the TFT 17 for detecting characteristic, and the gate driver circuit 16 is connected via a gate wiring 91 to the TFT 17.

The components that are the same as the first preferred embodiment denote the same reference numerals, and the overlapping descriptions are omitted here.

A-2. Configurations of Peripheral Circuits of TFT 17 for Detecting Characteristic

FIG. 10 is a circuit diagram showing the configurations of the peripheral circuits of the TFT 17 of the second preferred embodiment. The components that correspond to FIG. 9 bear the same reference numerals.

The gate of the TFT 17 for detecting characteristic is connected via the gate wiring 91 to an output buffer 6 of the gate driver circuit 16. The drain of the TFT 17 is connected to a terminal 101, and an analog voltage VDDA is applied to the terminal 101.

The source of the TFT 17 is connected to one end of a resistor R101 for detecting current (in some cases, hereinafter referred to simply as “resistor R101”) and the positive input terminal of an operational amplifier OP101. The other end of the resistor R101 is grounded.

The output of the operational amplifier OP101 is connected to the anode of a diode D101. The cathode of the diode D101 is connected to one end of a capacity C101. The other end of the capacity C101 is grounded.

One end of a resistor R103 is connected to the negative input terminal of the operational amplifier OP101. The other end of the resistor R103 is connected to one end of a discharging resistor R102 (a resistor R102) and the cathode of the diode D101. The other end of the resistor R102 is connected to the anode of the diode D101. The cathode of the diode D101 is connected to the negative input terminal of a comparator COMP102. A power source 102 is connected to the positive input terminal of the comparator COMP102.

The output of the comparator COMP102 is connected to one end of a resistor R104. The other end of the resistor R104 is connected to one end of a capacity C102 and the input of a current buffer 103. The other end of the capacity C102 is grounded. The output of the current buffer 103 is connected to a terminal 104, and the terminal 104 outputs a gate on voltage Vgh. The gate on voltage Vgh outputted from the terminal 104 is fed back to the gate driver circuit 16 via a line L2H. The line L2H corresponds to the line L2 in FIG. 9.

Instead of the gate wiring 91, a gate wiring 18 used to drive the pixel TFTs 11 may be shared. Alternatively, the gate wiring 91 may be disposed independently.

In the configuration shown in FIG. 10, the components other than the gate driver circuit 16 and the TFT 17 for detecting characteristic are contained in the power supply circuit 15. The operational amplifier OP101, the resistor R102, the resistor R103, the diode D101, and the capacity C101 constitute the peak hold circuit 106.

Alternatively, the peak hold circuit 106 may be made into a sample hold type by interposing a switch such as a JFET between the initial stage operational amplifier OP101 and the capacity C101 connected to the output thereof. Instead of disposing the switch, the second preferred embodiment realizes the peak hold circuit 106 by simply connecting in parallel the diode D101 and the discharging resistor R102 that is long in time constant.

B. Operation

The operation of the display device of the second preferred embodiment will be described below.

Like the pixel TFTs 11, the TFT 17 for detecting characteristic is driven by the gate driver circuit 16. The gate driver circuit 16 outputs a gate on voltage Vgh to the TFT 17 only during an on period of a horizontal cycle within a vertical period. Provided that the voltage Vgh is undefined at the initial stage, but there are some voltages in a certain range.

When the TFT 17 for detecting characteristic is turned on, a drain current Id of a certain magnitude flows from the terminal 101 via the TFT 17 to the resistor R101. When the drain current Id is applied to the resistor R101, a voltage is generated at a connecting point a between the resistor R101 and the drain of the TFT 17. This voltage is then inputted to the positive input terminal of the operational amplifier OP101 of the peak hold circuit 106.

When the voltage on the cathode side of the diode D101 is lower than the voltage inputted to the positive input terminal, the operational amplifier OP101 charges the capacity C101 to raise the voltage on the cathode side of the diode D101.

When the voltage applied to the positive input terminal of the operational amplifier OP101 is lowered, the output of the operational amplifier OP101 is also lowered. Nevertheless, the voltage on the cathode side of the diode D101 will not be lowered by the presence of the diode D101.

In this state, the voltage on the cathode side of the diode D101 continues rising. To avoid this, the discharging resistor R102 having a large resistance value is connected in parallel with the diode D101, thereby permitting a voltage drop in a given time at the time constant defined by the capacity C101 and the discharging resistor R102.

The voltage held by the capacity C101 is compared with a preset voltage (a reference voltage Vr) of the power source 102 in the comparator COMP102. This is followed by a feedback control in which the output of the comparator COMP102 is smoothed and inputted as a gate on voltage Vgh to the gate driver circuit 16.

For example, a gate on voltage Vgh that enables a drain current Id of 1 μA to flow when the value of the drain-source voltage Vds of the TFT 17 for detecting characteristic is 10 V, can be found from a simple calculation. That is, it is necessary to set the magnitude of an analog voltage VDDA to 11 V, and set the value of the resistor R101 for detecting current to 1 M Ω, and set a reference voltage Vr to 1 V.

Provided that in the initial state, the value of the gate on voltage Vgh outputted from the gate driver circuit 16 is lower than a desired value.

When the gate driver circuit 16 outputs the gate on voltage Vgh to the TFT 17 for detecting characteristic, the TFT 17 enters the on state. At this time, because the gate on voltage Vgh is lower than the desired value, a drain current Id having a smaller value than 1 μA required flows to the resistor R101 for detecting current.

As a result, the voltage held by the capacity C 01 of the peak hold circuit 106 is smaller than 1 V. The comparator COMP102 therefore outputs a high level voltage. By so doing, the capacity C102 is charged gradually, so that the gate on voltage Vgh is increased gradually.

The gate on voltage Vgh of the increased value is then inputted to the gate driver circuit 16. The gate driver circuit 16 outputs the increased gate on voltage to the TFT 17 for detecting characteristic.

Exceeding the desired gate on voltage Vgh by repeating the foregoing operation, the voltage generated at the end of the resistor R10 for detecting current exceeds 1 V, and therefore the comparator COMP102 outputs a low level signal. As a result, the value of the gate on voltage Vgh is gradually reduced.

Finally, the gate on voltage Vgh is balanced with such a value enabling the flow of a drain current Id of 1 μA. This results in the gate on voltage Vgh necessary to allow the drain current Id of 1 μA to flow to the TFT 17 for detecting characteristic.

C. Effects

Compared to the display device of the first preferred embodiment, the second preferred embodiment requires no circuit that turns on/off the TFT 17 for detecting characteristic. This more simplifies the circuit configuration. In particular, the sharing of the gate wiring 18 of the pixel TFT 1±1 facilitates the control of the TFT 17.

If the output number of the gate driver circuit 16 is larger than the gate wiring number necessary for the display area 12 (namely there is the rest), the TFT 17 for detecting characteristic can be connected to the rest output, allowing for its effective use.

### Third Preferred Embodiment

The first and second preferred embodiments have described the means for dynamically correcting the gate on voltage Vgh with the TFT 17 for detecting characteristic (refer to FIG. 1).

For example, in an LCD, the pixel TFTs 11 may deteriorate to cause a threshold shift and the like. Due to lack of the gate off voltage Vgl, the leak current may be increased to thereby deteriorate display quality.

For this reason, a display device according to a third preferred embodiment provides means for dynamically correcting a gate off voltage Vgl with the TFT 17 for detecting characteristic.

A. Configuration

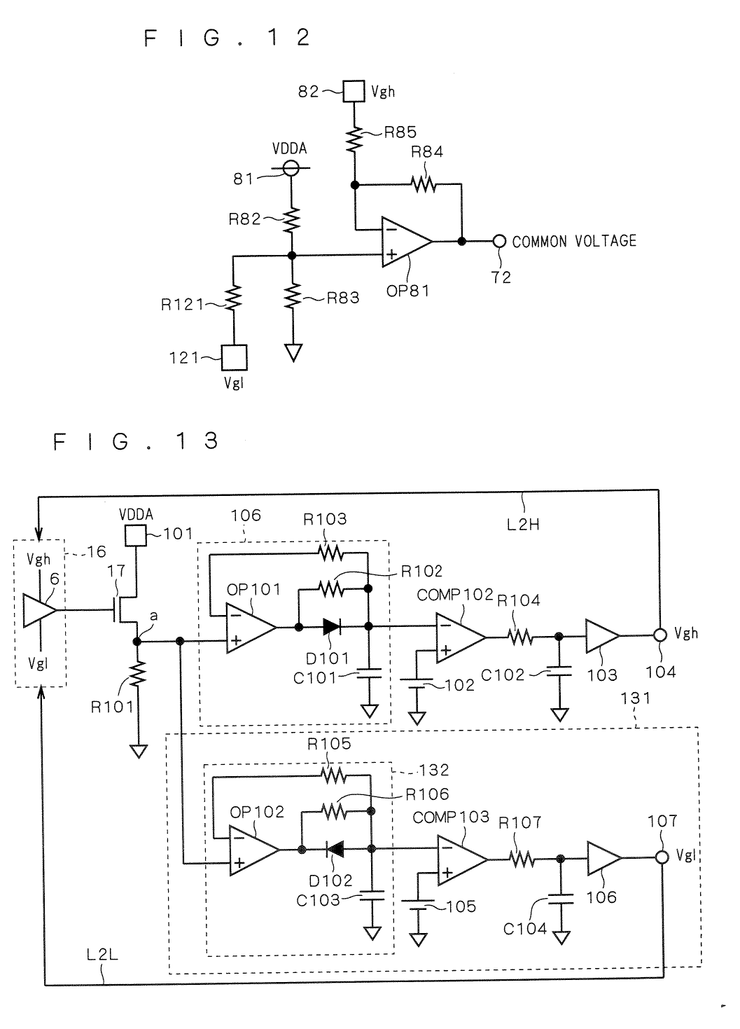

FIG. 11 is a circuit diagram showing the configuration of peripheral circuits of a TFT 17 for detecting characteristic according to the third preferred embodiment.

A power source 112 is connected to the negative input terminal of an operational amplifier OP111 (a gate voltage control circuit). The power source 112 applies a reference voltage Vr to the negative input terminal of the operational amplifier OP111.

The output of the operational amplifier OP111 is inputted to the gate of the TFT 17 for detecting characteristic. The output of the operational amplifier OP111 is outputted via a line L2 to a gate driver circuit 16 (refer to FIG. 1).

The source of the TFT 17 for detecting characteristic is grounded. The drain of the TFT 17 is connected, at a connecting point 111, to the positive input terminal of the operational amplifier OP111 and one end of a resistor R111 (the value of the resistor R111 is also referred to as “R111”). The other end of the resistor R111 is connected to a power source 113. The power source 113 applies an applied voltage Vs (a voltage Vs).

With reference to FIG. 1, it will be noted that the components other than the TFT 17 in the circuits shown in FIG. 11 are contained in the power supply circuit 15 (in FIG. 1), and the power sources 113 and 112 are generated within the power supply circuit 15.

B. Operation

The operation of the circuits shown in FIG. 11 will be described below. In the initial state, because the output of the operational amplifier OP111 is low, it is impossible to apply sufficient voltage to the gate of the TFT 17, resulting in a large value in the drain resistance of the TFT 17. Consequently, the voltage at the connecting point 111 is higher than the reference voltage Vr. The operational amplifier OP111 therefore increases the output.

An increase in the output of the operational amplifier OP111 causes a decrease in the drain resistance of the TFT 17 for detecting characteristic. This decreases the voltage inputted to the positive input terminal of the operational amplifier OP111, so that the operational amplifier OP111 decreases the output.

The foregoing operation is repeated until the reference voltage Vr inputted to the negative input terminal of the operational amplifier OP111 is equal to the voltage inputted to the positive input terminal.

That is, the output of the operational amplifier OP111 is controlled so that a drain current Id given by (Vs−Vr)/R111 flows to the TFT 17 for detecting characteristic.

For example, consider the case where, when the drain-source voltage Vds is 10 V, a drain current Id=1 nA is needed as the off characteristic of the TFT 17. Letting the applied voltage Vs be 11 V, and the reference voltage Vr be 10 V. By setting the resistance value of the resistor R111 to R111 (11 V−10 V)/1 nA=1 GΩ, a gate off voltage Vgl that enables a drain current Id of 1 nA to flow to the TFT 17 can be outputted from the operational amplifier OP111 to the gate driver circuit 16.

When the drain current Id is a micro current such as 1 nA, in some cases, the circuit as shown in FIG. 11 may not perform a desired operation due to the parasitic leak component of the peripheral circuit or the like, as described in the first preferred embodiment. In that event, like the first preferred embodiment, a plurality of TFTs 17 may be connected in parallel in order to increase the current flowing to the parallel-connected TFTs 17.

As described above in the first preferred embodiment, it is necessary to drive each of the TFTs 17 in the same manner as the pixel TFTs 11. Therefore, the TFT 17 is driven so that it is turned on only during an on period of a horizontal cycle once in a vertical cycle period.

To this end, a resistor may be disposed in series between the output of the operational amplifier OP111 and the gate of the TFT 17, and a signal STV may be level-shifted up to a gate on voltage Vgh and supplied to between the resistance and the gate. By so doing, the TFT 17 can be brought into the on state during the on period of the signal STV.

If the gate off voltage Vgl is variable, there is need to correct a common voltage. That is, when the pixel TFT 11 is turned off, the pixel voltage is lowered by Cgd/Cp×(Vgh−Vgl), as described in the first preferred embodiment.

It may therefore become necessary to correct the common voltage in response to the gate off voltage Vgl so that the voltage applied to the capacity Cp will be constant.

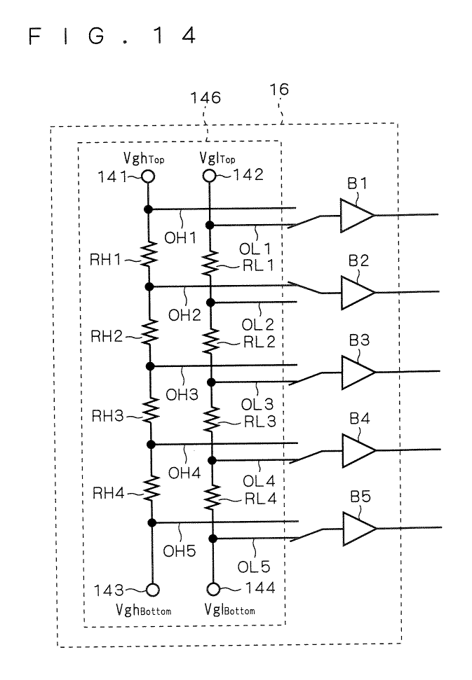

FIG. 12 is a circuit diagram showing the configuration of a common voltage generating circuit according to the third preferred embodiment. One end of a resistor R121 is connected at a connecting point between a resistor R82 and a resistor R83. The other end of the resistor R121 is connected to a terminal 121. A gate off voltage Vgl is applied to the terminal 121. Otherwise, the configuration is identical with the circuit as shown in FIG. 8. The components that correspond to FIG. 8 denote the same reference numerals, and the detailed description thereof is omitted here.

In the common voltage generating circuit as shown in FIG. 12, the gate off voltage Vgl is inputted to the positive input terminal of an operational amplifier OP81, and hence it operates to decrease the common voltage when the gate off voltage Vgl is increased, and increase the common voltage when the gate off voltage Vgl is decreased.

As a result, the voltage applied to the capacity Cp can be held constant with variations in the gate off voltage Vgl.

C. Effects

The foregoing configuration of the display device of the third preferred embodiment permits dynamic corrections of not only the voltage Vgh but also the voltage Vgl. For example, if the threshold value is shifted due to deterioration in a TFT, the pixel TFT 11 can always be driven under its optimum condition, enabling the display quality to be maintained.

In the display device of the third preferred embodiment, the operational amplifier OP111 controls the gate voltage so that a predetermined current identical with the current required for the pixel TFT 11 flows to the TFT 17 for detecting characteristic. It is therefore possible to obtain a further exact gate off voltage Vgl.

The display device of the third preferred embodiment is provided with the common voltage generating circuit that applies commonly the common voltage to a plurality of pixels. Since the common voltage is changed in response to the gate off voltage Vgl, the voltage applied to the pixel capacity 10 can be held constant with variations in the gate off voltage Vgl.

The circuit as shown in FIG. 11 can be used as a circuit for generating a gate on voltage Vgh by suitably selecting the values of the resistor R111, the power source 113, and the power source 112.

Specifically, the operational amplifier OP111 is capable of outputting a gate on voltage Vgh by selecting the values of the resistor R111, the power source 113, and the power source 112 so that the current flowing to the resistor R111 is equal to the drain current Id required when turning on the pixel TFTs 11.

### Fourth Preferred Embodiment

The third preferred embodiment has described the method for correcting the gate off voltage Vgl by employing the circuit as shown in FIG. 11. A fourth preferred embodiment describes a method for correcting both of a gate on voltage Vgh and a gate off voltage Vgl by employing the configuration as described in the second preferred embodiment.

A. Configuration

FIG. 13 is a circuit diagram showing the configuration of peripheral circuits of a TFT 17 for detecting characteristic according to the fourth preferred embodiment.

The configuration of the fourth preferred embodiment is the same as the second preferred embodiment, except that a circuit 131 that outputs a gate off voltage Vgl to the circuit as shown in FIG. 10 is further connected to the drain of the TFT 17 for detecting characteristic. The components that correspond to FIG. 2 denote the same reference numerals, and the overlapping descriptions are omitted here.

Firstly, the configuration of the circuit 131 will be described below. The positive input terminal of an operational amplifier OP102 is connected to the source of the TFT 17 for detecting characteristic. The output of the operational amplifier OP102 is connected to the cathode of a diode D102. The anode of the diode D102 is connected to one end of a capacity C103. The other end of the capacity C103 is grounded.

One end of a resistor R105 is connected to the negative input terminal of the operational amplifier OP102. The other end of the resistor R105 is connected to one end of a discharging resistor R106 and the anode of the diode D102.

The other end of the discharging resistor R106 is connected to the cathode of the diode D102. The anode of the diode D102 is connected to the negative input terminal of a comparator COMP103. A power source 105 is connected to the positive input terminal of the comparator COMP103. The power source 105 applies a reference voltage Vr.

The output of the comparator COMP103 is connected to one end of a resistor R107. The other end of the resistor R107 is connected to one end of a capacity C104 and the input of a current buffer 106. The other end of the capacity C104 is grounded. The output of the current buffer 106 is connected to a terminal 107, and the terminal 107 outputs a gate off voltage Vgl.

It is arranged so that the gate off voltage Vgl outputted from the terminal 107 is fed back via a line L2L to the gate driver circuit 16. The line L2L corresponds to the line L2 in FIG. 9.

The operational amplifier OP102, the resistor R105, the resistor R106, the diode D102, and the capacity C103 configure a minimum value detecting circuit 132. The minimum value detecting circuit 132 is different from the peak hold circuit 106 in that the diode D102 is directed in reverse direction.

B. Operation

It is assumed that, in the initial state, the value of the gate off voltage Vgl outputted from the gate driver circuit 16 is higher than a desired value, and that the reference voltage Vr applied from the power source 105 is set to a voltage generated when a desired leak current flows to a current detecting resistor R101.

When the voltage Vgl is outputted from the gate driver circuit 16 to the gate of the TFT 17 for detecting characteristic, the TFT 17 enters the off state. At that moment, because the gate off voltage Vgl is higher than the desired value, a leak current larger than that required flows to the current detecting resistor R101.

When the leak current flows to the resistor R101, a voltage is generated at a connecting point a. This voltage is then inputted to the positive input terminal of the operational amplifier OP102. Upon this input, the operational amplifier OP102 charges the capacity C103 up to the input voltage of the input terminal. Since the input voltage is higher than the positive input voltage of the comparator COMP103, the comparator COMP103 outputs a low level voltage (LOW).

By the output of the low level voltage from the comparator COMP103, the capacity C104 is gradually discharged, and the gate off voltage Vgl is gradually reduced. The gate off voltage Vgl lower than the initial state is then inputted to the gate driver circuit 16, and the gate driver circuit 16 outputs the reduced gate off voltage Vgl to the gate of the TFT 17 for detecting characteristic, and repeats the foregoing operation.

With less leak current, the voltage of the capacity C103 of the minimum value detecting circuit 132 is reduced and the comparator COMP103 starts output of HIGH. This results in the state balanced with the desired voltage Vgl.

C. Effects

Compared to the display device of the third preferred embodiment, the display device of the fourth preferred embodiment requires no circuit that turns on/off the TFT 17 for detecting characteristic, because the gate driver circuit 16 drives the TFT 17. In particular, the sharing of the gate wiring 18 of the pixel TFTs 11 facilitates the control of the TFT 17.

Not only the voltage Vgh but also the voltage Vgl can be corrected dynamically. For example, if the threshold value is shifted due to deterioration in the TFT, the pixel TFTs 11 can always be driven under their respective optimum conditions, enabling the display quality to be maintained.

In the fourth preferred embodiment, the circuit for correcting the voltage Vgl and the circuit for correcting the voltage Vgh employ the same TFT 17. There is normally a several-digits difference in the ratio of current between the on state and the off state. Therefore, if sufficient precision cannot be achieved with the same current detecting resistor R1001, the TFT 17 may be disposed independently.

### Fifth Preferred Embodiment

Even if the display device is used normally, there arises an inplane distribution of temperature in the display area 12 (refer to FIG. 1). For example, in an LCD, the temperature is high in the vicinity of the light source of a backlight, and the temperature is low at a position remote from the light source. In a display device disposed vertically, in general, the upper side of the display area 12 has a higher temperature than the lower side due to the convection of air.

If this temperature distribution exerts an undesirable influence on the characteristic of the pixel TFTs 11 (refer to FIG. 1) and deteriorates the display quality, the deterioration in the display quality can be suppressed by applying the configuration according to any one of the first to fourth preferred embodiments.

Specifically, in the case where the display device is disposed vertically and there is a temperature difference between the upper side of the display area 12 and the lower side thereof, the TFT 17 for detecting characteristic is provided at least two positions on the upper side and the lower side of the display area 12, respectively. The pixel TFT 11 disposed above the display area 12 is driven by the voltage Vgh and the voltage Vgl outputted from the TFT 17 disposed on the upper side, and the pixel TFT 11 disposed below the display area 12 is driven by an on voltage Vgh and an off voltage Vgl detected by the TFT 17 disposed on the lower side.

But, when the operating voltages at the two positions are simply determined from the TFTs 17 for detecting characteristic disposed on the upper side and the lower side, a sudden change of driving voltage at an arbitrary position in scanning rows may arise the disadvantage of the possibility that the boundary formed by this change can be observed.

Hence, the display device of the fifth preferred embodiment provides a gate driver circuit 16 that permits a smooth change of driving voltage between a pixel TFT 11 on the upper side of the display area 12 and a pixel TFT 11 on the lower side.

A. Configuration

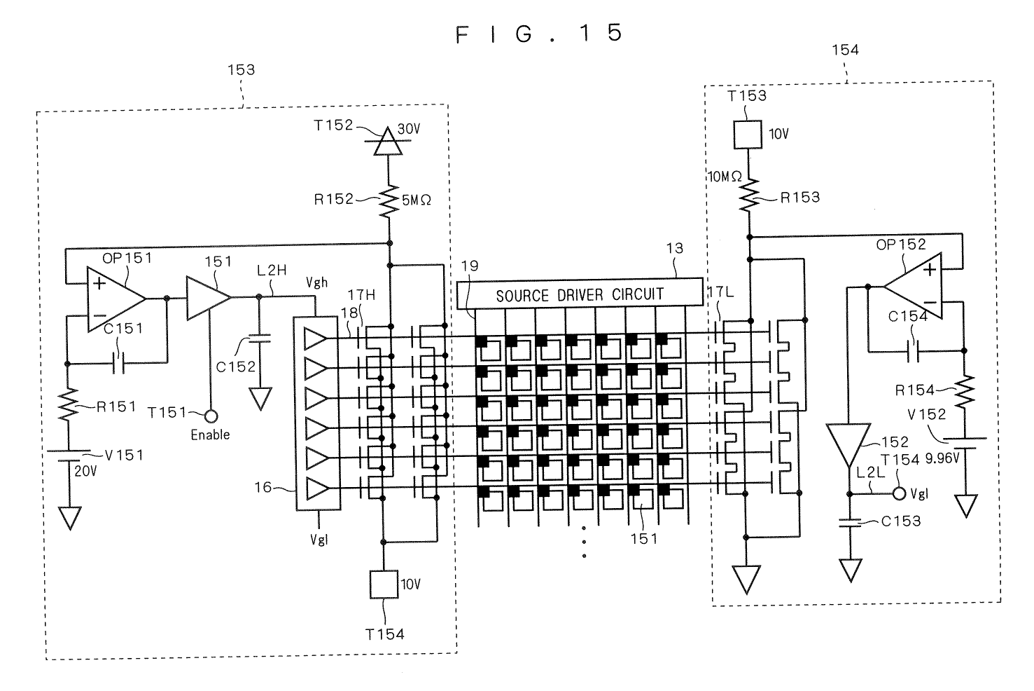

FIG. 14 shows an example of the configuration of the gate driver circuit 16 to make the boundary be invisible when the voltages Vgh and Vgl outputted to the pixel TFT 11 disposed on the upper side of the display area 12 are different from those outputted to the pixel TFT 11 disposed on the lower side.

For sake of simplicity, the scanning row is set to five rows in the gate driver circuit 16 as shown in FIG. 14. The gate driver circuit 16 of the fifth preferred embodiment is provided with a reference voltage part 146 (a voltage dividing part), in addition to output buffers B1 to B5. The configuration of the reference voltage part 146 will be described below.

One end of a resistor RH1 is connected to a terminal 141 and an output OH1. The other end of the resistor RH1 is connected to an output OH2 and one end of a resistor RH2. The other end of the resistor RH2 is connected to an output OH3 and one end of a resistor RH3.

The other end of the resistor RH3 is connected to an output OH4 and one end of a resistor RH4. The other end of the RH4 is connected to an output OH5 and a terminal 143.

A voltage Vgh_{Top} detected by the TFT 17 for detecting characteristic disposed on the upper side of the display area 12 is applied to the terminal 141. A voltage Vgh_{Bottom} detected by the TFT 17 on the lower side of the display area 12 is applied to the terminal 143.

One end of a resistor RL1 is connected to a terminal 142 and one end of an output OL1. The other end of the resistor RL1 is connected to an output OL2 and one end of a resistor RL2. The other end of the resistor RL2 is connected to an output OL3 and one end of a resistor RL3.

The other end of the resistor RL3 is connected to an output OL4 and a resistor RL4. The other end of the resistor RL4 is connected to an output OL5 and a terminal 144.

A voltage Vgh_{Top} detected by the TFT 17 for detecting characteristic disposed on the upper side of the display area 12 is applied to the terminal 142. A voltage Vgh_{Bottom} detected by the TFT 17 disposed on the lower side of the display area 12 is applied to the terminal 144.

The reference voltage part 146 is configured as above described. The inputs of the output buffers B1 to B5 are connected to the output of the reference voltage part 146, and the outputs of the output buffers B1 to B5 are connected to the gates of the pixel TFTs 11 arranged in the first to fifth rows of the display area 12, respectively.

B. Operation

The gate on voltage Vgh_{Top} and the gate on voltage Vgh_{Bottom} are divided into a plurality of voltages by the resistors RH1 to RH4. It is arranged so that the voltage is lowered stepwise from the voltage Vgh_{Top} to the voltage Vgh_{Bottom}.

The gate off voltage Vgh_{Top} and the gate off voltage Vgh_{Bottom} are divided into a plurality of voltages by the resistors RL1 to RL4. It is arranged so that the voltage is lowered stepwise from the voltage Vgh_{Top} to the voltage Vgh_{Bottom}.

When the pixel TFT 11 in a certain row (the second row in the example in FIG. 14) requires the on state, the gate driver circuit 16 controls the output buffer B2 in that row so as to select the output OH2 of the reference voltage part 146. The output buffers B1, and B3 to B5 connected to other rows are controlled so as to select the outputs OL1, and the outputs OL3 to OL5 of the reference voltage part 146.

C. Effects

Thus, the display device of the fifth preferred embodiment is provided with the reference voltage part 146 that divides the outputs of the plurality of TFTs 17 for detecting characteristic.

Therefore, the gate on voltage Vgh or the gate off voltage Vgl applied to the pixel TFTs 11 can be changed smoothly so that it is decreased gradually from the upper side to the lower side. As a result, the boundary of the voltage is invisible.

### Sixth Preferred Embodiment

The gate driver circuit 16 of the fifth preferred embodiment is complicated than a normal gate driver circuit, thereby increasing the manufacturing costs.

Further, in order to dynamically correct the common voltage in response to variations in the voltages Vgl and Vgh, it is necessary to know by any means the voltage of the selected horizontal scanning line 18. The circuit therefor is inevitably complicated.

To this end, the sixth preferred embodiment provides means that permits temperature corrections of the voltages Vgh and Vgl with a simple circuit configuration.

A. Configuration

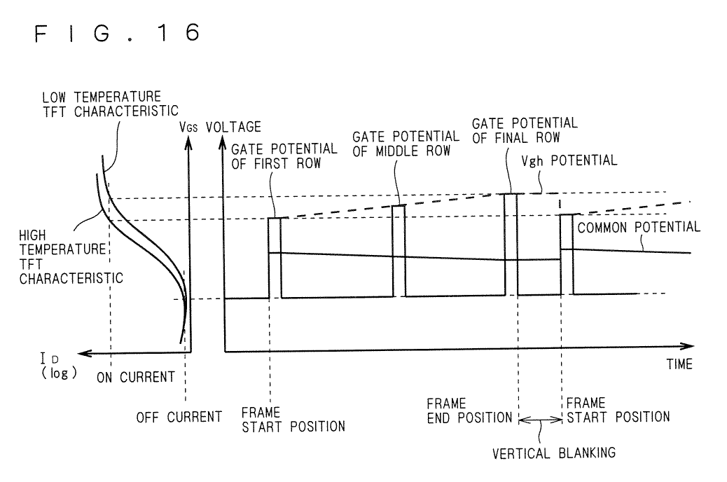

FIG. 15 is a circuit diagram showing the configuration of the display device of the sixth preferred embodiment. Pixels TFTs 11 (refer to FIG. 1) are disposed at pixels 151 arranged in a matrix-shape.

These pixels 151 can be selected by the horizontal scanning lines 18, and the voltages of vertical data lines 19 are written therein. For purposes of convenience, it is assumed that the voltages of the data lines 19 are in a range of 0 V to 10 V.

Since control signals for driving a source driver circuit 13 and the gate driver circuit 16 are normal ones, their respective descriptions are omitted here.

In FIG. 15, a circuit 153 is a circuit for generating a gate on voltage Vgh. The sixth preferred embodiment employs the same circuit as that of FIG. 11 in the third preferred embodiment, as a circuit for generating the gate on voltage Vgh.

TFTs 17H for detecting characteristic along with pixel TFTs 11 are connected to the scanning lines 18, respectively. In the example shown in FIG. 15, the two TFTs 17H are connected for each of the scanning lines 18. This aims at avoiding any malfunction due to a small mobility of the TFTs 17H, as described above in the first preferred embodiment. Hence, any number of TFTs 17H may be connected if a desired operation is ensured.

All of the drains of these TFTs 17H for detecting characteristic are connected to one another. This is true for the sources thereof.

The sources of the TFTs 17H for detecting characteristic are connected to a terminal T154. A voltage of 10 V (the maximum value of a source wiring voltage) is applied to the terminal T154. The drains of the TFTs 17H are connected to a terminal T152 via a resistor R152 for detecting current of 5 M Ω. A voltage of 30 V is applied to the terminal T152.

The drains of the TFTs 17H are connected to the positive input terminal of an operational amplifier OP151. One end of a resistor R151 and one end of a capacity C151 are connected to the negative input terminal of the operational amplifier OP151. The other end of the resistor R151 is connected to a power source V151, and the power source V151 applies a voltage of 20 V.

The other end of the capacity C151 is connected to the output of the operational amplifier OP151. The output of the operational amplifier OP151 is connected to the input of a current buffer 151 with Enable control. The output of a current buffer 15 is connected to the gate driver circuit 16 and one end of a capacity C152. The other end of the capacity C152 is grounded.

The configuration of a circuit 154 will be described below. The circuit 154 is a circuit for generating a voltage Vgl.

One end of a resistor R153 is connected to a terminal T153. The resistance value of the resistor R153 is 10 MΩ. A voltage of 10 V is applied to the terminal T153.

The other end of the resistor R153 is connected to the positive input terminal of the operational amplifier OP152 and the drains of TFTs 17L for detecting characteristic. The two TFTs 17L are connected for each of the scanning lines 18. The TFTs 17L connected to the scanning lines 18 in the first to third rows are connected in series.

The TFTs 17L connected to the scanning lines 18 in the fourth to sixth rows are also connected in series. Four sets of the serially-connected TFTs 17L are mutually connected in parallel. The drain of the TFT 17L at one end in the set of the serially-connected TFTs 17L is connected to the other end of the resistor R153, and the source of the TFT 17L at the other end is grounded.

The negative input terminal of the operational amplifier OP152 is connected to one end of a resistor R154, and the other end of the resistor R154 is connected to a voltage V152. A voltage of 9.96 V is applied to the voltage V152.

A capacity C154 is connected to between the output and the negative input terminal of the operational amplifier OP152. The output of the operational amplifier OP152 is connected to the input of a current buffer 152. The output of the current buffer is connected to a terminal T154 and one end of a capacity C153. The other end of the capacity C153 is grounded. The terminal T154 outputs a voltage Vgl.

The voltage Vgl outputted from the terminal T154 is inputted to the gate driver circuit 16.

In FIG. 15, the boost converter circuit 32, the charge pump circuit 33 and the like as shown in FIG. 4 are omitted, and the voltages applied to the power source V151 and the terminal T152, the voltage applied to the terminal T153, and the power source V152 are generated by the power supply circuit 15.

B. Operation

The operation of a circuit 153 is the same as that of the circuit in FIG. 11 of the third preferred embodiment, and therefore its detailed description is omitted here.

In the circuit 153, the reference voltage given by the V151 is set to 20 V. Therefore, when the drain-source voltage Vds of the TFTs 17 is (20 V−10 V)=10 V, the circuit 153 generates a gate on voltage Vgh in order that the drain current Id becomes (30V−20V)/5MΩ=2 μA.

Provided that the gate driver circuit 16 is performing the operation as shown in FIG. 3. This results in the state that any one of the scanning lines 18 is selected for a certain period of time, or none of them is selected for a vertical blanking period.

Since any one of the scanning lines 18 is selected in the period of time other than the vertical blanking period, in this example, the gates of the two parallel-connected TFTs 17H for detecting characteristic are turned on. Therefore, the circuit 153 outputs a gate on voltage Vgh that enables a drain current Id of 1 μA to flow per TFT 17H.

A current buffer 151 with Enable control is disposed at the subsequent stage of the operational amplifier OP151.

The current buffer 151 is provided for the following reason. Since no TFT 17H is selected in a vertical blanking period, any change of the voltage Vgh does not permit the flow of a desired current. The operational amplifier OP151 therefore continues to increase the voltage until it saturates. It follows that the voltage Vgh is too high at the start of the next frame. To avoid this, during the blanking period, an Enable terminal is brought into the Disable state so as not to cause variations in the voltage Vgh.

If desired to drive so that all of the scanning lines 18 also enter the non-selected state not only in the blanking period but also in the normal display period, it is similarly required to keep the voltage Vgh unchanged for that period. Any other means may be employed because the object is to avoid too large variations in the voltage Vgh.

A circuit 154 is a circuit for generating a voltage Vgl. The operation of the circuit 154 is also the same as the circuit in FIG. 11 of the third preferred embodiment, and therefore its detailed description is omitted here.

The operational amplifier OP152 is connected to the power source V152 that applies a reference voltage of 9.96 V. Therefore, the voltage Vgl is set to the voltage enabling the flow of a current of 4 nA that causes a voltage drop of 10−9.96=40 mV at the current detecting resistance R154.

Consequently, a current of 1 nA flows to a set of the serially-connected TFTs 17L. Similarly, a current of 1 nA flows to other sets of the serially-connected ones.

The reason for connecting in series the TFTs 17L for detecting characteristic is as follows. During the display period, any one of the scanning lines 18 enters the selected state, and the TFTs 17L for detecting characteristic are turned on. If they are not connected in series, the turning on of any one of the TFTs 17L makes it impossible to reduce the current to a certain value or below by any reduction of the gate off voltage Vgl.

Although it is essentially sufficient to connect the two TFTs 17L in series, it can also be considered that both gates enter a half on state between the time a certain scanning line 18 is turned off and the time the next scanning line 18 is turned on. In that event, a large current might flow. To avoid this, it is preferable to connect the three TFTs 17L in series.

In fact, the current values for setting the voltage Vgh and the voltage Vgl may be determined from display characteristics. However, if selected the values extremely close to the limits of the TFT 17H and TFT 17L, no solution can be obtained due to the individual variations. This is out of control. It is therefore preferable to allow a margin by setting the current for determining the voltage Vgh to a slightly low value, and the current for determining the voltage Vgl to a slightly high value. With respect to the voltage to be outputted thereafter, the voltage Vgh may be set to a slightly high value, and the voltage Vgl to a slightly low value.

The operation when the display of the sixth preferred embodiment is actually driven will be described with reference to FIG. 16. FIG. 16 is a diagram for explaining the operation when the display of the sixth preferred embodiment is actually driven.

The actually generated voltage Vgh can be obtained by adding a gate-source voltage Vgs to the minimum value of a source wiring voltage. To make the drawing understandable, it is illustrated schematically, with parts omitted.

It is assumed that the upper part of a screen is hot and the mobility of each of the pixel TFTs 11 arranged on the upper side is high, and that the lower part of the screen is low in temperature and the mobility of each of the pixel TFTs 11 arranged on the lower side is low.

When the display frame is started and the scanning line 18 in the first row is selected, a slightly low voltage Vgh is generated based on the TFTs 17 for detecting characteristic mounted in the first row.

Then, the scanning is advanced. In the intermediate part, when the voltage Vgh corresponding to the TFT 17 on the scanning line 18 selected at that time, and the lowermost scanning line 18 at the end of the frame are selected, a slight high Vgh is generated based on the characteristic of the TFTs 17 mounted in the final row. Thereafter, the vertical blanking period is started, and the value of the voltage Vgh is held constant. When the first row is selected again, the voltage Vgh has the value corresponding to the first row.

The voltage Vgl remains almost unchanged. This is because, when the scanning lines 18 extend over 1000 rows, selecting one of them causes just a 1/1000 influence. If the entire display device is hot thereby to change the average characteristic, the value of the voltage Vgl can, of course, be controlled in response to that change.

C. Effects

The display device of the sixth preferred embodiment is further provided with the plurality of TFTs 17L and TFTs 17H for detecting characteristic, and they are arranged at the ends of the gate lines 18 of the pixel TFTs 11 arranged in the plurality of rows.

Thus, the simple circuit configuration permits prevention of display characteristic deterioration due to the characteristics of the pixel TFTs 11, which can be caused by the in-plane temperature distribution, as well as the individual variations of the pixel TFTs 11, temperature change, and aged change.

There are further provided with a large number of the vertically disposed TFTs 17H and 17L that are sequentially selected and adjusted. It is therefore possible to cope with the case of requiring a non-linear driving voltage, for example, when a certain portion is locally hot (i.e., having a different TFT characteristic).

In the sixth preferred embodiment, the TFTs 17H for detecting characteristic that are used to determine the voltage Vgh are disposed on the side of the gate driver circuit 16, and the TFTs 17L for detecting characteristic that are used to determine the voltage Vgl are disposed on the side remote from the gate driver circuit 16. Alternatively, the former and the latter may be disposed vice versa.

It is however preferable to dispose the voltage Vgh on the side of the gate driver circuit 16, because there is no rounding of the gate voltage due to the resistors and the capacities of the gate wirings 18, so that any one of them is always susceptible to be turned on.

In the cases where, due to the rounding of the gate voltage, none of the scanning lines 18 is turned on at the change of the scanning lines, or two or more of the scanning lines 18 are turned on, the above-mentioned Enable signal may be used to stop a feedback loop in such a period of time, thereby preventing variations in the Vgh voltage.

Although not be illustrated in FIG. 15, it is also possible to dynamically correct the common voltage by incorporating the common voltage generating circuit as shown in FIG. 12. In the display device of the sixth preferred embodiment, the gate on voltage Vgh and the gate off voltage Vgl outputted to the pixel TFTs 11 are changed for each of the scanning lines 18, so that the common voltage can be corrected so as to be suitable for each of them.

While the invention has been shown and described in detail, the foregoing description is in all aspects illustrative and not restrictive. It is therefore understood that numerous modifications and variations can be devised without departing from the scope of the invention.

What is claimed is:

1. A display device comprising:
a plurality of pixels that are arranged in a matrix-shape on a substrate and are respectively provided with a pixel TFT; and
at least one TFT for detecting characteristic that is formed on said substrate so as to have the same characteristic as said pixel TFT, and detects an on voltage or an off voltage for driving said pixel TFT,
said at least one TFT for detecting characteristic being driven so as to agree with said pixel TFT in a period of an on state.

2. The display device according to claim 1 wherein,
said at least one TFT for detecting characteristic has a control terminal and a current input terminal that are connected to each other; and
said on voltage or said off voltage is detected by applying a bias current to a connecting part between said control terminal and said current input terminal.

3. The display device according to claim 1, further comprising:
a gate voltage control circuit that controls a gate voltage of said at least one TFT for detecting characteristic, wherein,
said at least one TFT for detecting characteristic detects said on voltage or said off voltage by control of said gate voltage that enables flow of a predetermined current identical with a current required for said pixel TFT.

4. The display device according to claim 1 wherein said at least one TFT for detecting characteristic is driven by a gate driving circuit that drives said pixel TFT.

5. The display device according to claim 1, further comprising:
a common voltage generating circuit that commonly applies a common voltage to said plurality of pixels, wherein,
said common voltage is changed in response to said on voltage or said off voltage.

6. The display device according to claim 1 wherein said at least one TFT for detecting characteristic contains a plurality of TFTs for detecting characteristic, said plurality of TFTs for detecting characteristic being connected in parallel.

7. The display device according to claim 1 wherein,
said at least one TFT for detecting characteristic contains a plurality of TFTs for detecting characteristic;
a voltage dividing part is further provided that divides an output between said plurality of TFTs for detecting characteristic; and
said pixel TFT is driven by an on voltage or an off voltage that is divided by said voltage dividing part.

8. The display device according to claim 1 wherein,
said at least one TFT for detecting characteristic contains a plurality of TFTs for detecting characteristic; and
said plurality of TFTs for detecting characteristic are arranged at an end of a gate wiring of said pixel TFT arranged in a plurality of rows.
